(19) United States
(12) Patent Application Publication
(10) Pub. No.: US 2011/0294326 A1
(43) Pub. Date: Dec. 1, 2011

(54) FLOATING CONNECTOR

(75) Inventors: Tetsugaku TANAKA, Shinagawa (JP); Manabu Shimizu, Shingawa (JP); Koichi Kiryu, Shinagawa (JP)

(73) Assignee: FUJITSU COMPONENT LIMITED, Tokyo (JP)

(21) Appl. No.: 13/114,611

(22) Filed: May 24, 2011

(30) Foreign Application Priority Data
May 25, 2010 (JP) 2010-119435

(51) Int. Cl. H01R 13/64

(52) U.S. Cl. 439/248

(57) ABSTRACT

A floating connector including a receptacle having a receptacle contact and a receptacle housing for supporting the receptacle contact, a plug having plug contact and a plug housing for supporting the plug contact, and a positional deviation absorbing mechanism provided in at least one of the receptacle and the plug for capable of absorbing a positional deviation between the receptacle housing and the plug housing at a time of fitting between the receptacle housing and the plug housing. Each of the receptacle contact and the plug contact has a terminal portion abutted to each other at the time of fitting between the receptacle housing and the plug housing, and at least one of the receptacle contact and the plug contact has a support part for supporting the terminal portion in a manner movable relative to the supporting housing.

### BACKGROUND OF THE INVENTION

1. Field of the Invention

The present invention relates to a floating connector.

2. Description of the Related Art

Conventionally, there is a known floating connector in which a movable housing is provided movably relative to a fixed housing for a connector fixed to a substrate board so as to absorb positional deviation at the time of fitting between a receptacle (female connector) and a plug (male connector). Such a floating connector is described in Japanese Unexamined Patent Publication (kokai) No. 2007-103189 (JP 2007-103189 A). In such a floating connector, the receptacle and the plug are fitted and fixed to each other by the contact pressure in the fitting part, and a receptacle contact and a plug contact are abutted to each other in the fitting part.

However, since the receptacle and the plug are fitted and fixed by contact pressure in the fitting part, if such a floating connector is used in an apparatus such as a vehicle where vibration frequently occurs, sliding wear is generated between the contacts, and therefore, the connector's life may be reduced.

### SUMMARY OF THE INVENTION

According to an aspect of the present invention, a floating connector including a receptacle having a receptacle contact and a receptacle housing for supporting the receptacle contact; a plug having plug contact and a plug housing for supporting the plug contact; and a positional deviation absorbing mechanism provided in at least one of the receptacle and the plug for capable of absorbing a positional deviation between the receptacle housing and the plug housing at a time of fitting between the receptacle housing and the plug housing; wherein each of the receptacle contact and the plug contact has a terminal portion abutted to each other at the time of fitting between the receptacle housing and the plug housing, and wherein at least one of the receptacle contact and the plug contact has a support part for supporting the terminal portion in a manner movable relative to the supporting housing.

### BRIEF DESCRIPTION OF THE DRAWINGS

The object, features and advantages of the present invention will become more apparent from the following description of embodiments taken in conjunction with the accompanying drawings, in which:

FIG. 1 is a perspective view showing a floating connector according to a first embodiment of the present invention;

FIG. 2a is a view seen in the direction of an arrow “a” of FIG. 1;

FIG. 2b is a view seen in the direction of an arrow b of FIG. 1;

FIG. 3 is a perspective view showing the plug of FIG. 1;

FIG. 4a is a view seen in the direction of an arrow “a” of FIG. 3;

FIG. 4b is a view seen in the direction of an arrow b of FIG. 3;

FIG. 5 is a sectional view taken along a line V-V of FIG. 4b;

FIG. 6 is a sectional view taken along a line VI-VI of FIG. 4a;

FIG. 7 is a perspective view showing the receptacle of FIGS. 2a and 2b;

FIG. 8a is a view seen in the direction of an arrow “a” of FIG. 7;

FIG. 8b is a view seen in the direction of an arrow b of FIG. 7;

FIG. 9 is a sectional view taken along a line IX-IX of FIG. 8b;

FIG. 10 is a sectional view taken along a line X-X of FIG. 8a;

FIG. 11 is a sectional view taken along a line XI-XI of FIG. 2b;

FIG. 12 is a sectional view taken along a line XII-XII of FIG. 2a;

FIG. 13 is a perspective view showing a plug according to a second embodiment of the present invention;

FIG. 14 is a sectional view taken along a line XIV-XIV of FIG. 13;

FIG. 15 is a perspective view showing a receptacle according to a second embodiment of the present invention;

FIG. 16 is a sectional view taken along a line XVI-XVI of FIG. 15;

FIG. 17 is a perspective view showing a floating connector according to a second embodiment of the present invention;

FIG. 18 is a sectional view taken along a line XVIII-XVIII of FIG. 17;

FIG. 19 is a sectional view taken along a line XIX-XIX of FIG. 17;

FIG. 20a is a view useful for explaining an operation at the time of fitting of the connector;

FIG. 20b is a view useful for explaining an operation at the time of fitting of the connector;

FIG. 21a is a view showing a variant of the second embodiment of the present invention;

FIG. 21b is a view showing a variant of the second embodiment of the present invention;

FIG. 22 is an enlarged view showing a cam groove of FIG. 21b;

FIG. 23 is a perspective view showing a variant of FIG. 13;

FIG. 24 is a sectional view taken along a line a-a of FIG. 23;

FIG. 25 is a view showing a configuration of a leaf spring member used for the floating connector of FIG. 23;

FIG. 26a is a view showing an example of the operation of the floating connector of FIG. 23;

FIG. 26b is a view showing an example of the operation of the floating connector of FIG. 23;

FIG. 26c is a view showing an example of the operation of the floating connector of FIG. 23.

### DETAILED DESCRIPTION

### First Embodiment

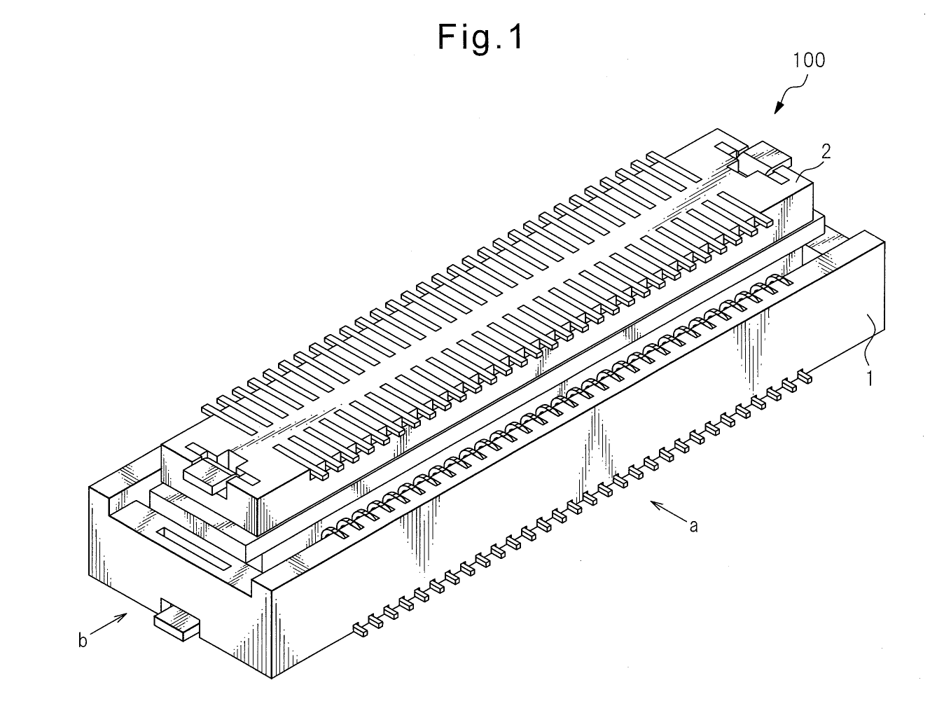

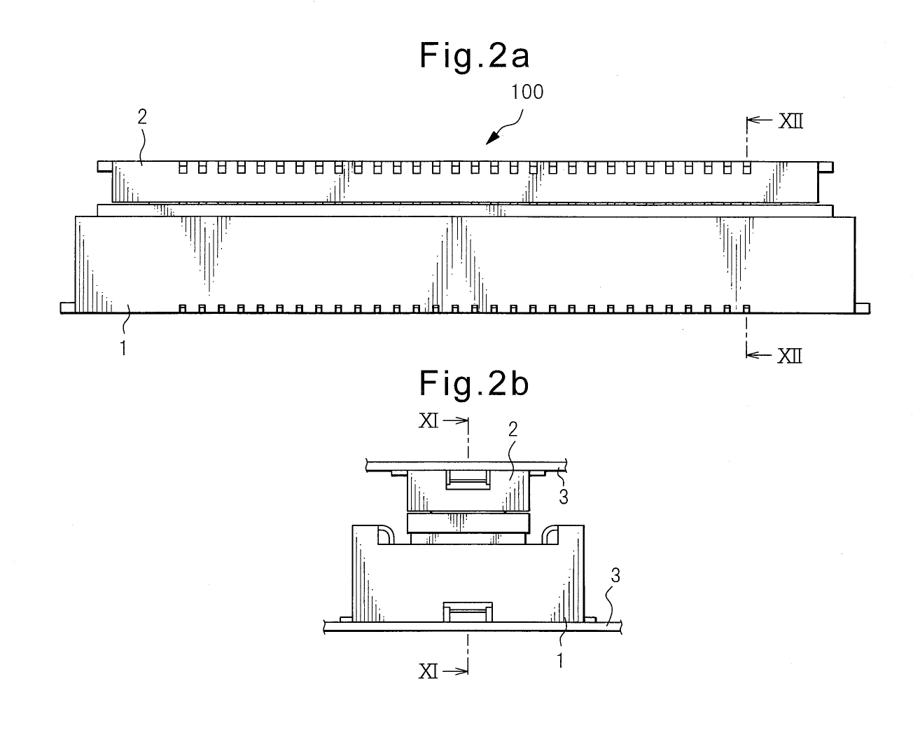

Hereafter, referring to FIGS. 1 to 12, a first embodiment of the present invention will be described below. FIG. 1 is a perspective view showing a floating connector 100 according to the first embodiment, FIGS. 2a and 2b are its side view (a view seen in the direction of an arrow “a” in FIG. 1) and its front view (a view seen in the direction of an arrow b in FIG. 1), respectively. The floating connector 100 includes a plug 1 and a receptacle 2 capable of being fitted to each other.

As shown in FIGS. 2a and 2b, the plug 1 and the receptacle 2 are mounted to a surface of a substrate board 3, respectively, and are fitted and fixed to each other on the opposite side of the mounting surfaces. FIGS. 1, 2a and 2b show states of a fit of the connector 100, respectively, wherein substrate boards 3 are electrically connected to each other by fitting between the plug 1 and the receptacle 2. The floating connector 100 according to this embodiment has a vibration absorbing capability as described later, and therefore is suitable to be used in vehicles, in which vibration frequently occurs.

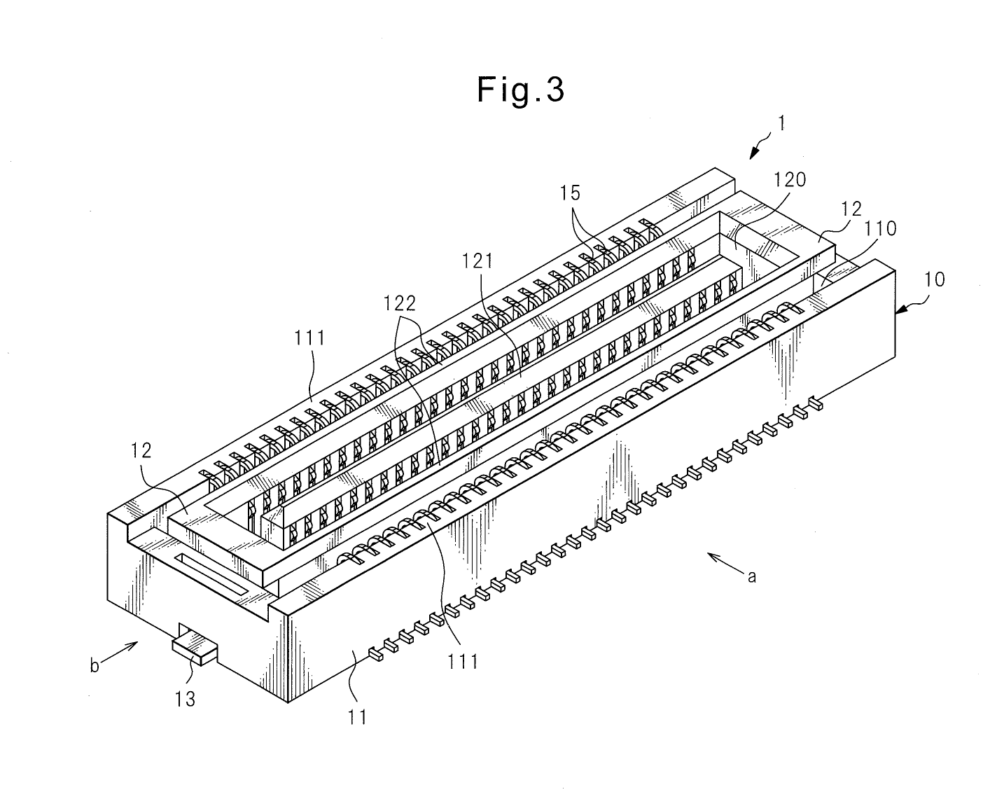

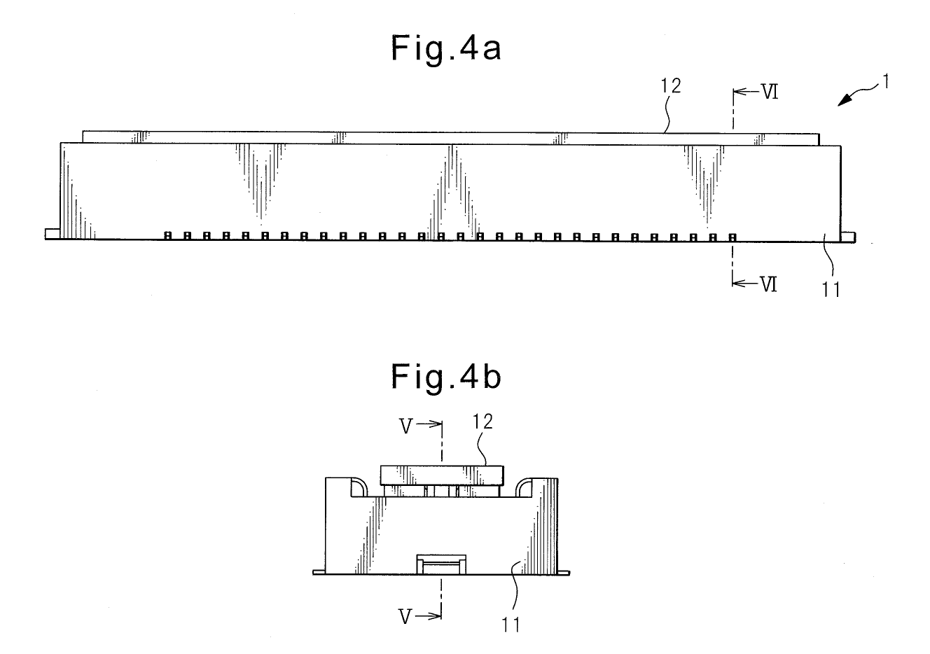

FIG. 3 is a perspective view showing the plug 1, and FIGS. 4a and 4b are its side view (a view seen in the direction of an arrow “a” of FIG. 3) and its front view (a view seen in the direction of an arrow b of FIG. 3), respectively. The plug 1 has a housing 10 of electrical insulating resin molding, and a plurality of electrical conductive contacts 15 fixed to the housing 10 in integral molding. The contacts 15 are composed of an elastically deformable metal. A lot of contacts 15 are arranged at equal spacing along the longitudinal direction of the housing 10. The housing 10 includes a fixed housing 11 and a movable housing 12 formed in a generally elongated box shape.

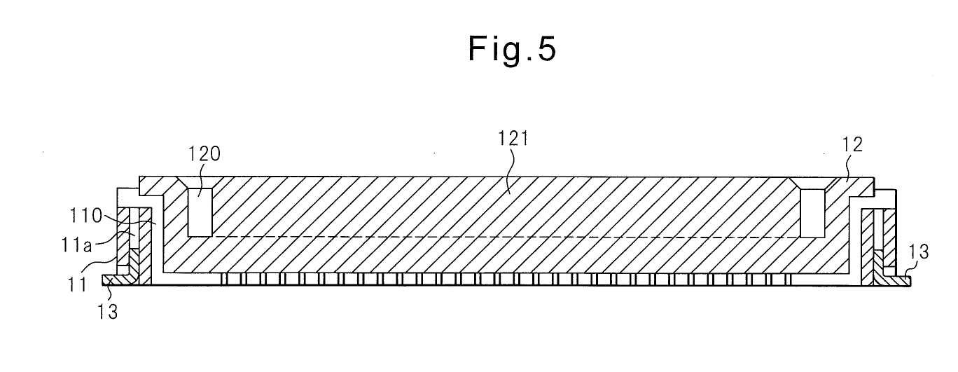

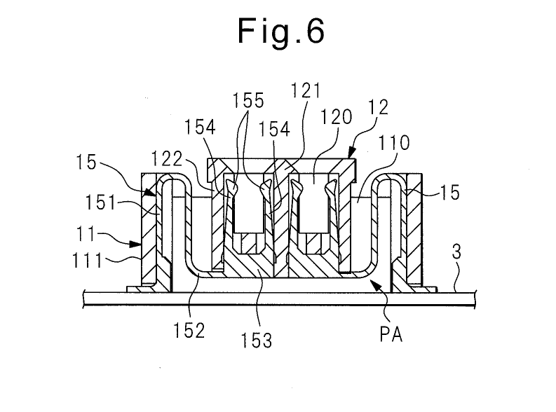

FIG. 5 is a sectional view taken along a line V-V of FIG. 4b, and FIG. 6 is a sectional view taken along a line VI-VI of FIG. 4a. The fixed housing 11 is fixed to the substrate board 3 with the movable housing 12 contained movably in a housing part 110 of the fixed housing 11. In a housing part 120 of the movable housing 12, a center wall 121 is projected from the bottom surface of the movable housing 12 at the center in width direction. The housing part 120 is formed in the shape of a groove so as to surround the center wall 121. Reference numeral 13 denotes a fitting hardware for fixing the fixed housing 11 to the substrate board 3. The fitting hardware 13 has a generally L-shape in cross section. h One end portion of the fitting hardware 13 is pressed into a fitting groove 11a which penetrates the center of a side end of the fixed housing 11, and the other end portion is projecting from the side end surface of the fixed housing 11.

As shown in FIG. 6, a pair of contacts 15 are provided so as to be separated from each other in width direction of the housing 10 on both sides of the center wall 121. Thus, the contacts 15 are provided from a side wall 111 of the fixed housing 11 toward a side wall 122 and the center wall 121 of the movable housing 12, in symmetric arrangement in width direction with respect to the center wall 121 interposed therebetween. More specifically, each contact 15 has a base portion 151 penetrating the side wall 111 of the fixed housing 11 in height direction, a S-shaped portion 152 bent and folded in generally S-shape from one end (upper end in the drawing) of the side wall 111 of the fixed housing 11 to the bottom portion of the side wall 122 of the movable housing 12, and a terminal portion 153 disposed between the side wall 122 and the center wall 121 of the movable housing 12.

One end portion (lower end portion in the drawing) of the base portion 151 projects along the bottom surface of the fixed housing 11 to the outside of the side wall 111, and is connected to the substrate board 3. The terminal portion 153 is a so-called fork type, and a distal end portion (upper end in the drawing) of the terminal portion 153 is provide with a fork portion 154 branched in the shape of a fork. One branch of the fork portion 154 is fixed to the side wall 122 and the other branch is fixed to the center wall 121. At the tip of each fork portion 154, a protrusion portion 155 projecting inward in width direction is provided.

In the present embodiment, the movable housing 12 is supported via the elastically deformable contact 15 by the fixed housing 11. Therefore, the movable housing 12 is relatively movable in horizontal direction and in height direction relative to the fixed housing 11 by elastic deformation of the S-shaped portion 152. Thus, the plug 1 of the present embodiment has a positional deviation absorbing mechanism PA, and the connector 100 has a floating structure.

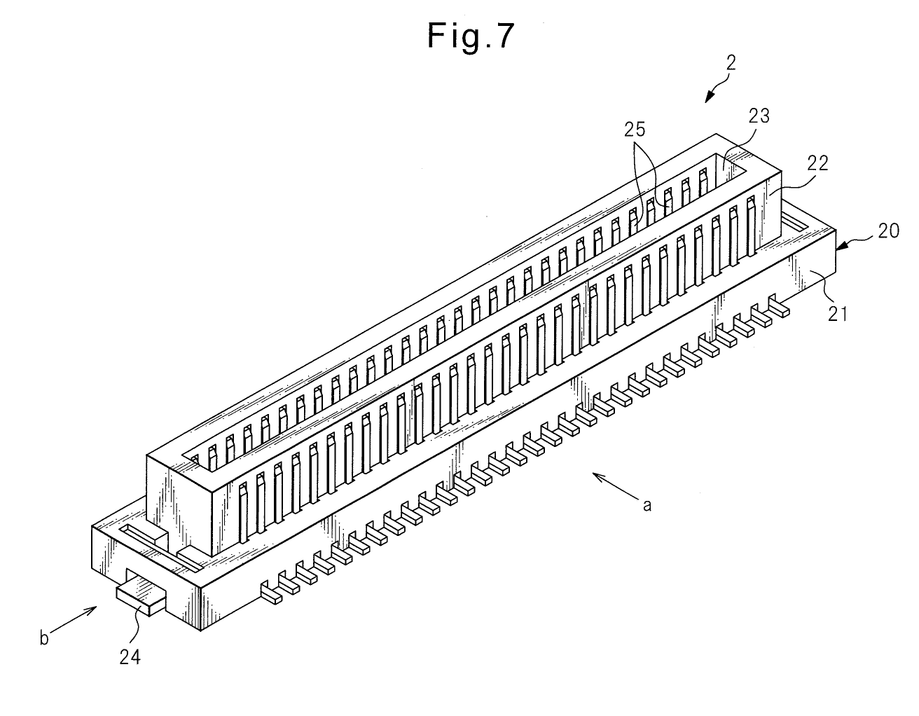

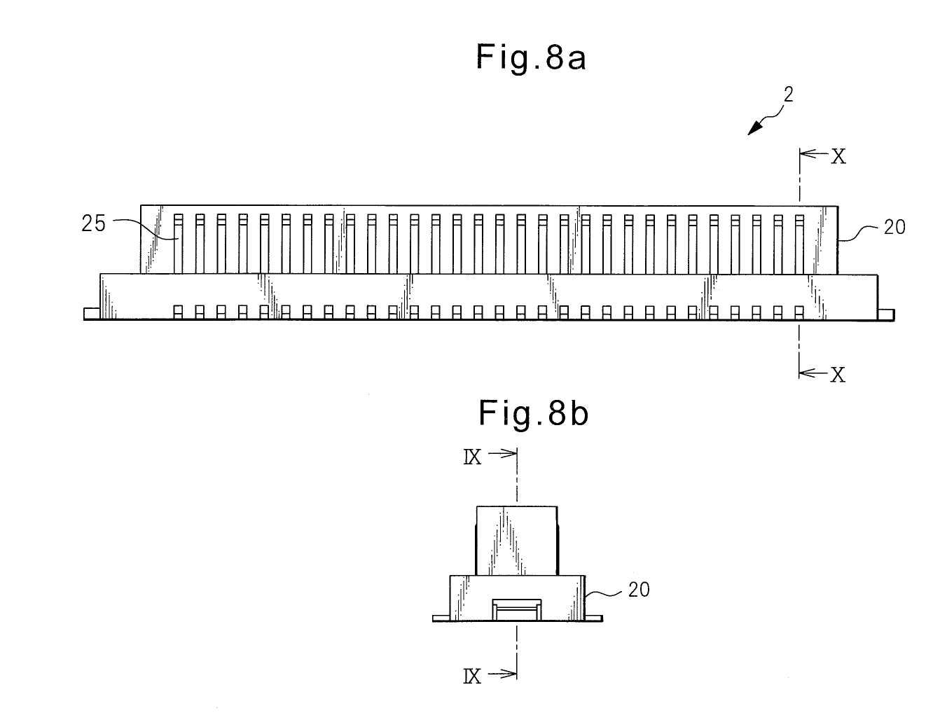

FIG. 7 is a perspective view showing a receptacle 2, and FIGS. 8a and 8b are its side view (a view seen in the direction of an arrow “a” of FIG. 7) and front view (a view seen in the direction of an arrow b of FIG. 7), respectively. The receptacle 2 includes a housing 20 that is an electrical insulating resin molding, and a plurality of electrical conductive contacts 25 fixed to the housing 20. The contacts 25 are composed of an elastically deformable metal. A lot of contacts 25 are arranged along the longitudinal direction of the housing 20 at equal spacing. The housing 20 is formed in a generally elongated box shape in correspondence to the housing 10 of the plug 1.

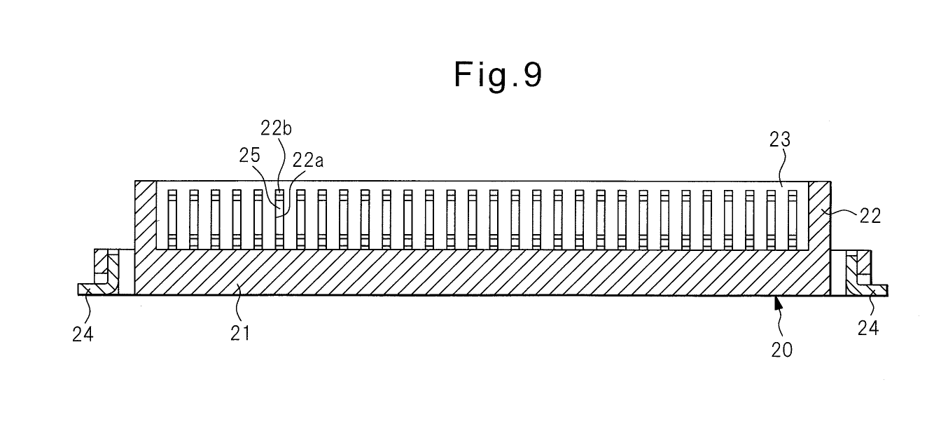

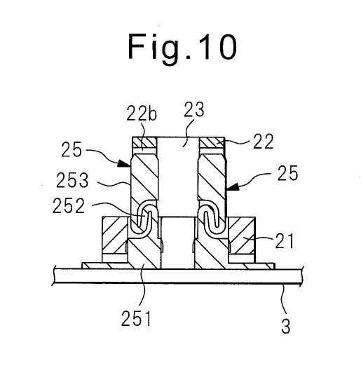

FIG. 9 is a sectional view taken along a line IX-IX of FIG. 8b, and FIG. 10 is a sectional view taken along a line X-X of FIG. 8a. The housing 20 has a base 21 and a side wall 22 projected above the base 21. A housing part 23 is formed inside the side wall 22. In the housing part 23, the center wall 121 of the mobable housing 12 of the plug 1 can be fitted, and the side wall 22 can be fitted into the housing part 120 of the plug 1. Reference numeral 24 denotes a fitting hardware for fixing the housing 20 to the substrate board 3.

As shown in FIG. 10, a pair of contacts 25 is provided in the housing 20 in a manner separated from each other, so that each contacts 25 is arranged symmetrically in the width direction with respect to the housing part 23 interposed therebetween. Thus, the contact 25 has a base portion 251 penetrating the base 21 of the housing 20, a terminal portion 253 arranged inside the side wall 22, and a spring portion 252 connecting the base portion 251 with the terminal portion 253.

The base portion 251 is fixed to the base 21 of the housing 20 integrally. One end portion (lower end in FIG. 10) of the base portion 251 projects outside the base 21 along the bottom surface of the housing 20 to connect to the substrate board 3. On the other hand, the terminal portion 253 and the spring portion 252 are arranged in a hole 22a formed in the side wall 22 with a gap 22b so as to be movable in the hole 22a in height direction and in width direction. The spring portion 252 is formed in a generally elongated S-shape, and the inside end portion (upper end portion in FIG. 10) in the width direction of the base portion 251 and the outside end portion (lower end portion in FIG. 10) in width direction of the terminal portion 253 are connected by the spring portion 252 with each other. The terminal portion 253 relatively moves relative to the base portion 251 by elastic deformation of the spring portion 252.

Next, operation of the floating connector 100 according to the first embodiment will be described. When the substrate board 3 having the plug 1 mounted thereon is fitted to the substrate board 3 having the receptacle 2 mounted thereon, the side wall 22 of the housing 20 of the receptacle 2 is pressed into the housing part 120 of the movable housing 12 of the plug 1. At this time, the movable housing 12 of the plug 1 is movable relative to the fixed housing 11 by the positional deviation absorbing mechanism PA, so that a positional deviation of the plug 1 and the receptacle 2 at the time of fitting can be corrected. When the plug 1 and the receptacle 2 in fitting state are pulled apart in the direction separating them from each other, the plug 1 and the receptacle 2 can be separated from each other.

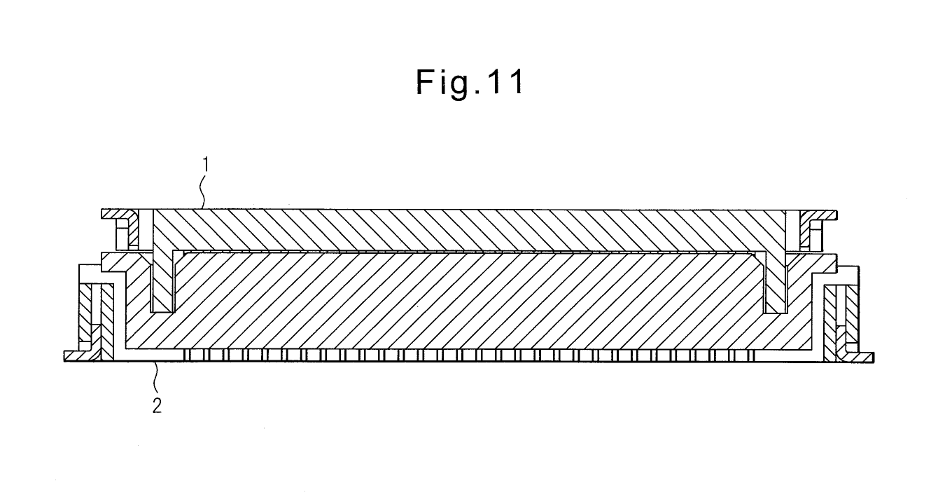

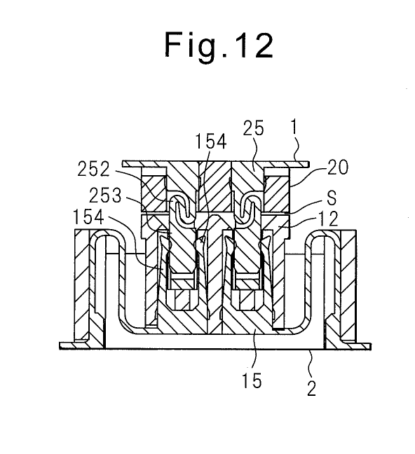

FIGS. 11 and 12 are sectional views taken along a line XI-XI of FIG. 2b and a line XII-XII of FIG. 2a, respectively, showing the fitting state of the plug 1 and the receptacle 2. As shown in FIG. 12, in the fitting state of the connector 100, the terminal portion 253 is sandwiched between a pair of fork portions 154 at the tip of the terminal portion 153, and thereby the contacts 15 and 25 are abutted to each other. At this time, there is a gap “s” between the end surface of the movable housing 12 of the plug 1 and the end surface of the housing 20 of the receptacle 2 which are opposed to each other.

In this state, if some vibration acts on the substrate board 3, the spring portion 252 deforms elastically with the terminal portions 153 and 253 of the contacts 15 and 25 abutted to each other. As a result, the housing 20 of the receptacle 2 relatively moves relative to the movable housing 11 of the plug 1, so that transmission of the vibration between the plug 1 and the receptacle 2 is suppressed, and the vibration is damped by the action of the spring portion 252, and therefore, the vibration of the connector as a whole can be suppressed.

In accordance with the first embodiment, the following effects can be obtained:

(1) The spring portion 252 is provided between the base portion 251 and the terminal portion 253 of the contact 25 of the receptacle 2, so that the terminal portion 253 relatively moves relative to the housing 20 via the spring portion 252. Therefore, vibration between the plug 1 and the receptacle 2 is absorbed by the spring portion 252, and even if the connector 100 is used in an environment where vibrations occur frequently, the state in which the terminal portions 153 and 253 of the contacts 15 and 25 are abutted to each other can be maintained. As a result, sliding wear between the terminal portions 153 and 253 can be reduced, and the life of the connector 100 can be increased.

(2) The positional deviation absorbing mechanism PA is provided in the plug 1, and the spring portion 252 is provided in the receptacle 2, so that the floating structure and the vibration absorbing structure of the connector 100 are provided in separate members with each other, and therefore, the configuration of the connector 100 can be simplified.

(3) The terminal portion 153 of the contact 15 is formed in fork shape so as to sandwich the terminal portion 253 of the contact 25 from both sides. As a result, the terminal portions 153 and 253 are firmly connected to each other so that sliding wear at the terminal portions 153 and 253 can be reduced.

### Second Embodiment

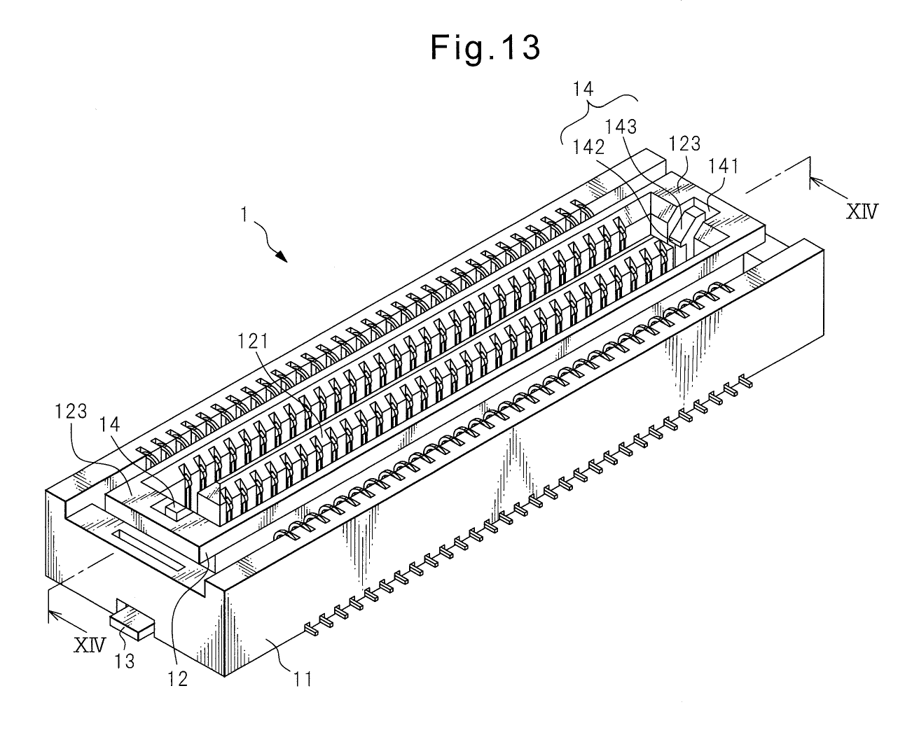

Referring to FIGS. 13 to 22, a second embodiment of the present invention will be described below. In FIGS. 13 to 22, parts identical to parts shown in FIGS. 1 to 12 are denoted by same reference numerals, and differences from the first embodiment are mainly described below. A floating connector 100 according to the second embodiment is provided with, in addition to the configuration of the first embodiment, an engaging part for engaging the plug 1 with the receptacle 2, and an urging member for urging the receptacle 2 in a direction separating it from the plug 1.

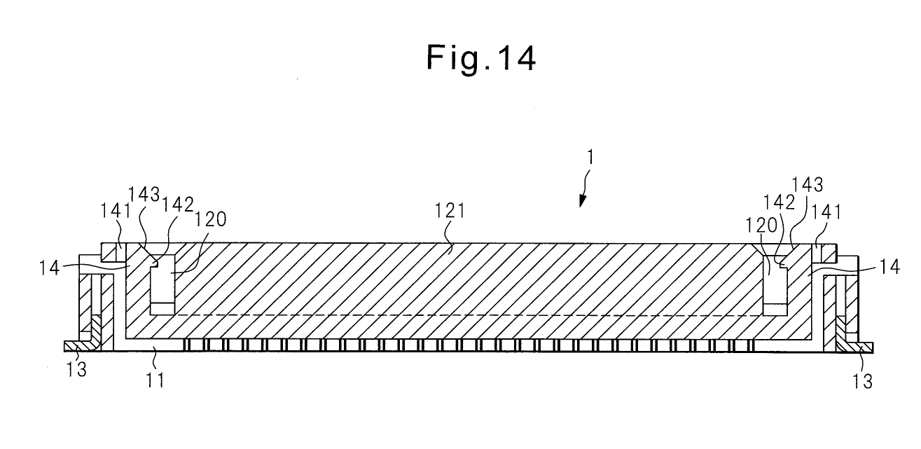

FIG. 13 is a perspective view showing a plug 1 according to the second embodiment, and FIG. 14 is a sectional view taken along a line XV-XV of FIG. 13. On side walls 123 positioned on both longitudinal sides of the center wall 121 of the movable housing 12, engaging parts 14 are respectively provided. The engaging part 14 is provided in a groove 141 formed on the side wall 123 so as to be elastically deformable outward in longitudinal direction. On the end portion (upper end portion in FIG. 14) of the engaging part 14, a protrusion portion 142 is formed projecting in the housing part 120 inward in the longitudinal direction. A corner portion 143 provided above the protrusion portion 142 is chamfered so as to facilitate fitting of the side wall 22 into the housing part 120.

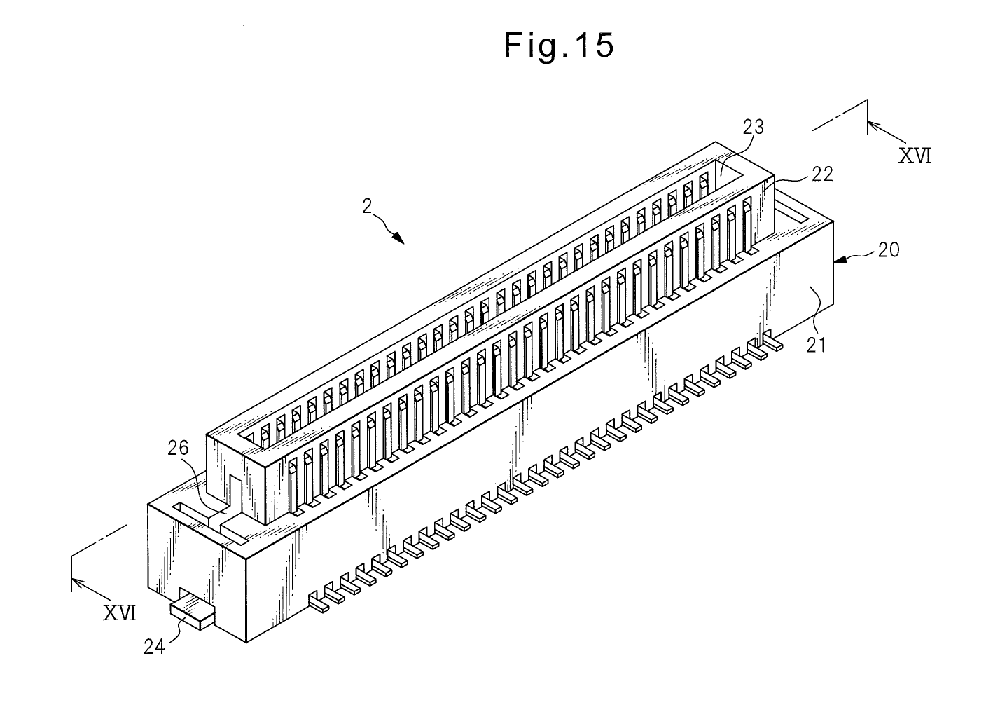

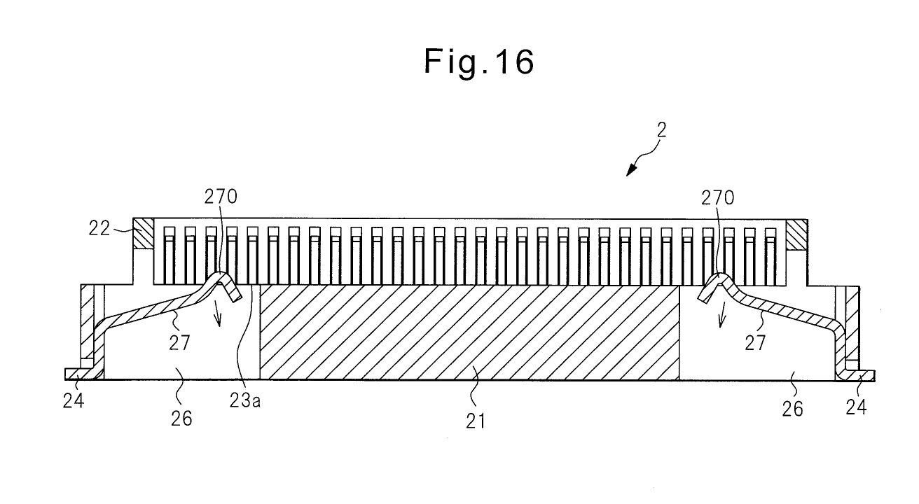

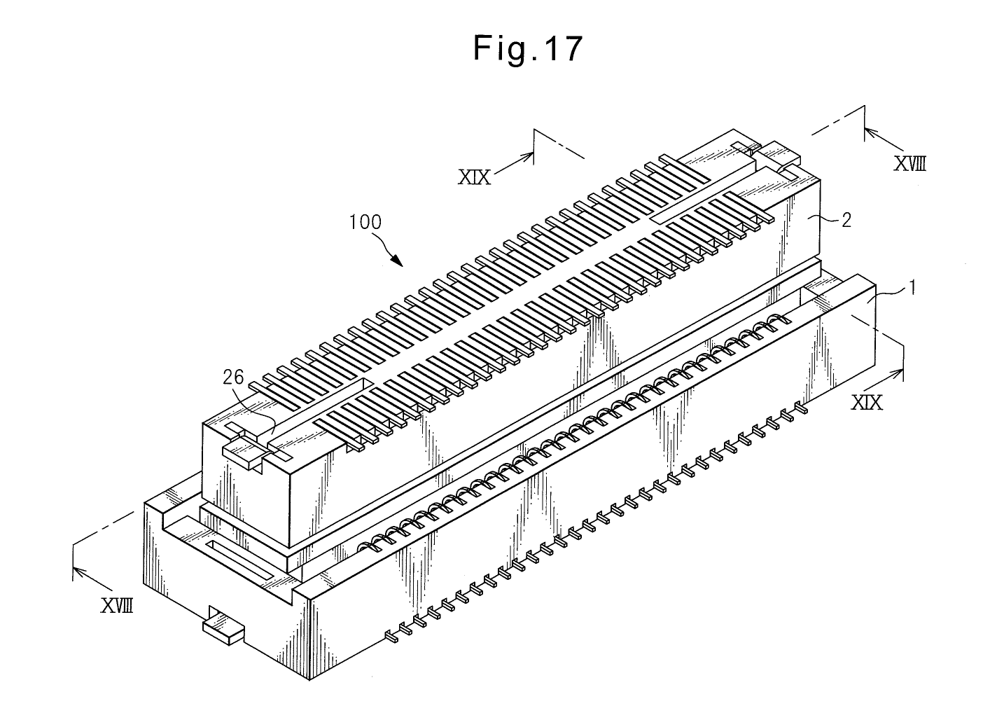

FIG. 15 is a perspective view showing a receptacle 2 according to the second embodiment, and FIG. 16 is a sectional view taken along a line XVI-XVI of FIG. 15. On both longitudinal ends of the receptacle 2, in the center portion in width direction, slit holes 26 (see FIG. 17) are respectively opened from the bottom surface of the base 217 to the end portion (neighborhood of upper end portion in the figure) of the side wall 22. An elongated metal hook 27 is disposed in each slit hole 26.

The hook 27 is constructed, for example, by extending the fitting hardware 24 in an elongated shape. One end portion of the hook 27 is fixed to the base 21 of the housing 20. At the other end portion of the hook 27, a folded portion 270 in a bent shape is formed The folded portion 270 projects outward (upward in the drawing) from the bottom surface 23a of the side wall 23. Thus, the hook 27 is supported in cantilever fashion on the base 21 so as to be deformable elastically in the direction shown by an arrow of FIG. 16 with respect to the support part as a fulcrum.

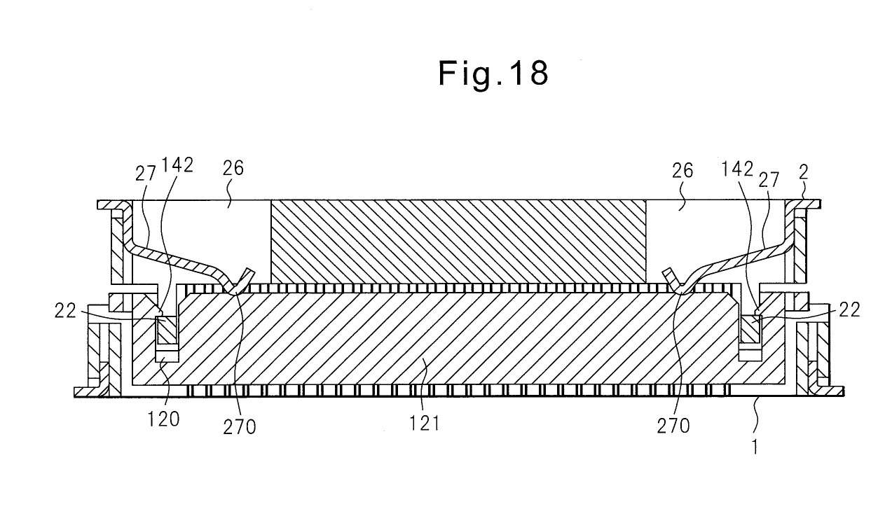

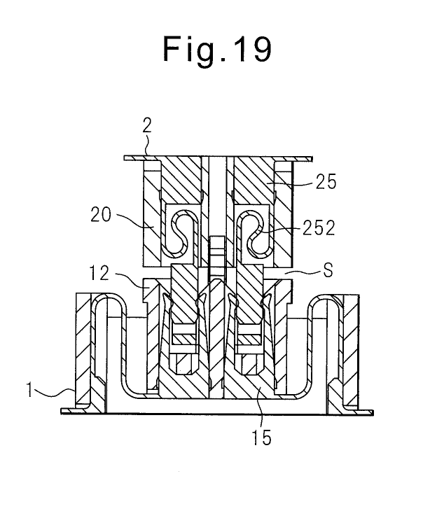

In the second embodiment, too, the floating connector 100 is fitted by pressing the side wall 22 of the receptacle 2 into the housing part 120 of the plug 1. FIG. 17 is a perspective view showing the fitting state of the floating connector 100 according to the second embodiment, and FIGS. 18 and 19 are sectional views taken along a line XVIII-XVIII and a line XIX-XIX of FIG. 17, respectively. As shown in FIGS. 18 and 19, in the fitting state of the connector 100, the engaging protrusion portion 142 of the plug 1 is inserted into the slit hole 26, so that the engaging part 14 engages with the end portion of the side wall 22. The folded portion 270 of the hook 27 is abutted to the end surface (upper end surface in the drawing) of the center wall 121 of the plug 1, so that the receptacle 2 is pushed upward in the drawing by the spring force of the hook 27.

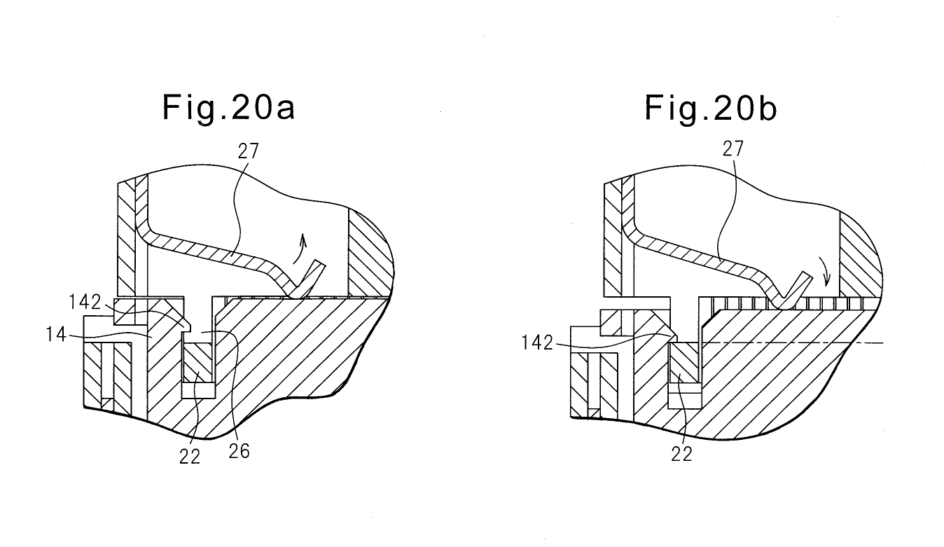

Operation of the connector 100 at the time of fitting will be described in more detail below with reference to FIG. 20. When the receptacle 2 and the plug 1 are fitted with each other, at first, as shown in FIG. 20a, the side wall 22 of the receptacle 2 is pressed into the housing part 120 against the spring force of the hook 27, until the engaging protrusion portion 142 climbs over the end portion of the side wall 22 and reaches to the slit hole 26. At this time, a force is exerted to the spring portion 252 of the contact 25 so that the contact 25 is compressed in the height direction.

After the engaging protrusion portion 142 is inserted into the slit hole 26, when the pressing force of the receptacle 2 is removed, the receptacle 2 is pushed back by the spring force of the hook 27 as shown in FIG. 20b, and the engaging protrusion portion 142 is abutted against the end surface of the side wall 22. In this state, the gap “s” (FIG. 19) between the movable housing 12 of the plug 1 and the housing 20 of the receptacle 2 becomes maximum. Therefore, the compression force acting on the spring portion 252 of the contact 25 is removed, and the spring portion 252 returns to initial state.

Thus, in the second embodiment, the engaging part 14 is provided in the movable housing 12 of the plug 1, and the slit hole 26 corresponding to the engaging part 14 is provided in the receptacle 2, so that the engaging part 14 engages with the side wall 22 of the receptacle 2 at the time of fitting the connector 100. Therefore, fall-off of the fitting portion during usage of the connector 100 can be reliably prevented. Further, the hook 27 is provided as an urging member for urging the plug 1 and the receptacle 2 in the direction separating them from each other, so that the spring portion 252 of the contact 25 is returned to initial state at the time of fitting the connector 100. Therefore, normal operation of the spring portion 252 is ensured, and good vibration absorbing effect is obtained.

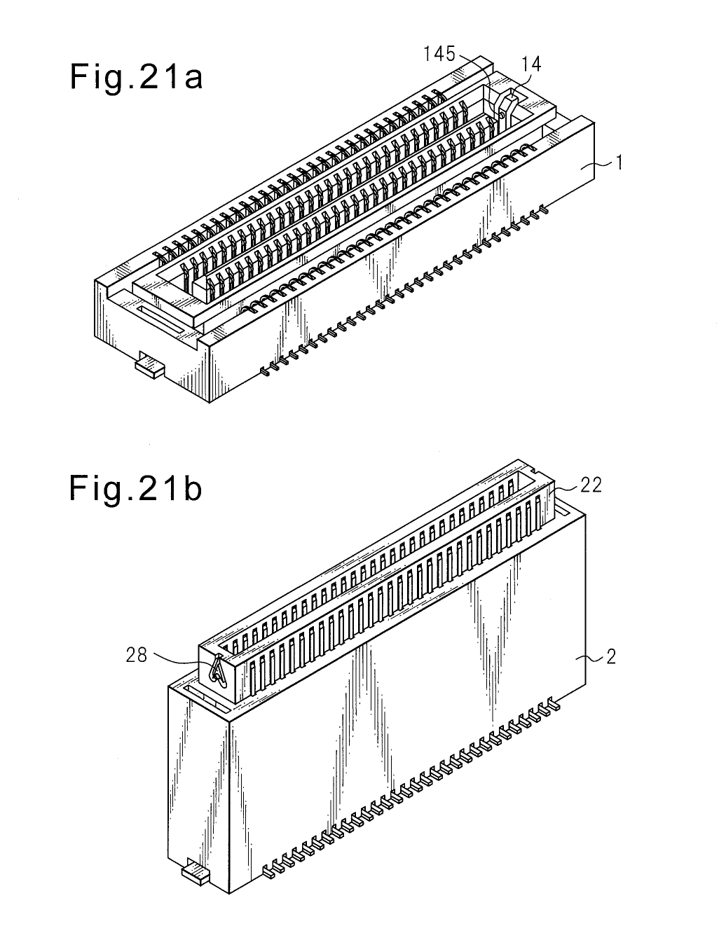

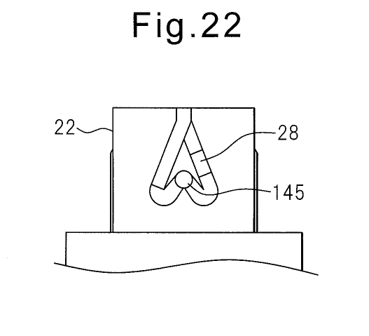

The configurations of the engaging part and the urging member are not limited to those described above. For example, as shown in FIGS. 21a and 21b, a circular or semi-spherical protrusion portion 145 may be provided on the engaging part 14 of the plug 1 in place of the engaging protrusion portion 142, and a heart-shaped cam grove 28 (so-called heart cam) may be provided on the side wall 22 of the receptacle 2 corresponding to the protrusion portion 145, so that the protrusion portion 145 engages with the cam groove 28. As shown in FIG. 22, a step difference as is well known to those skilled in the art is provided on the bottom surface of the cam groove 28, so that, when the receptacle 2 is pressed into the plug 1, the protrusion portion 145 can be fixed to the deep end of the cam groove 28.

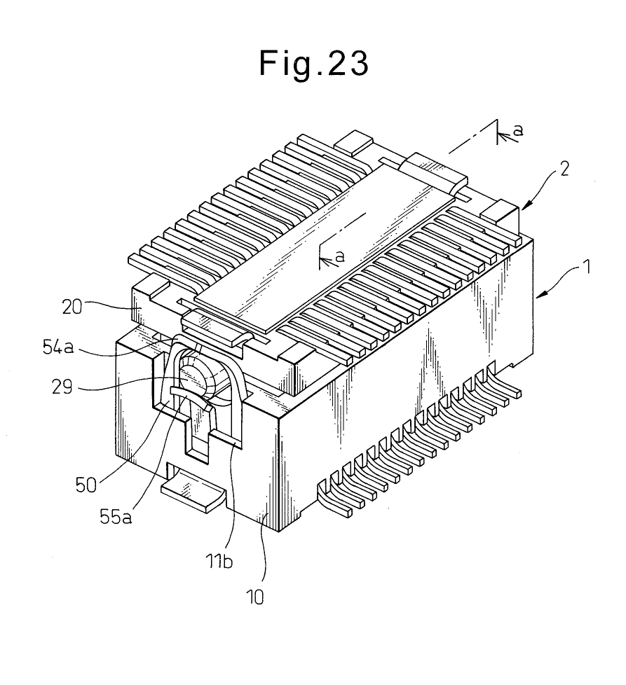

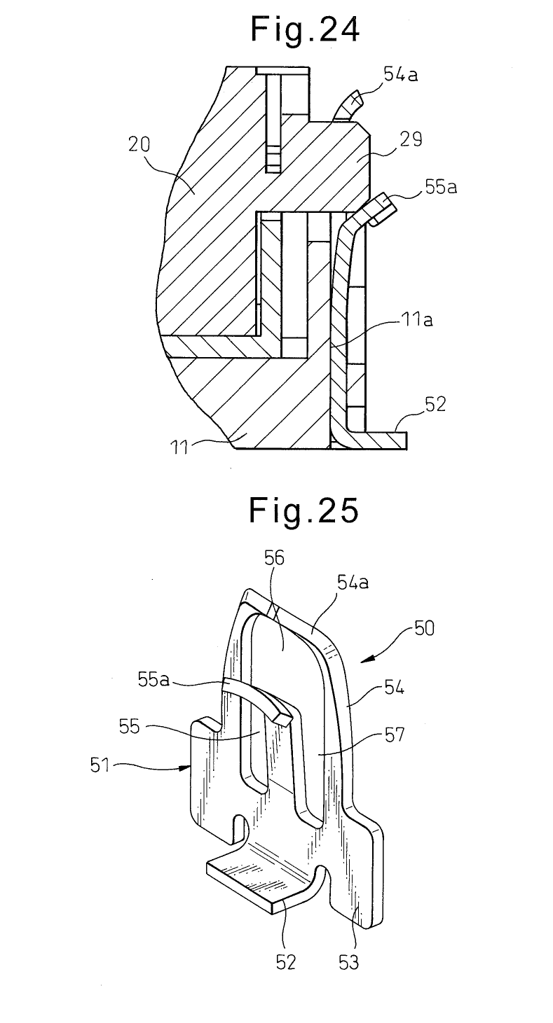

FIG. 23 is a perspective view showing a floating connector having a different construction of the engaging part, and FIG. 24 is a sectional view (sectional view taken along a line a-a of FIG. 23) of its essential part. In FIGS. 23 and 24, a leaf spring member 50 is pressed and attached to a fitting groove 11a of the side end portion of the housing 10 (fixed housing 11) of the plug 1. On both ends of the housing 20 of the receptacle 2, a protrusion portion 29 of a generally cylindrical shape projects generally perpendicular to the fitting direction, and the protrusion portion 29 engages with the leaf spring member 50 at the time of fitting between the housings 10 and 20.

FIG. 25 is a perspective view showing a leaf spring member 50. The leaf spring member 50 is formed, for example, by punching a sheet material having resiliency such as spring steel in a predetermined shape and bending and folding it. The leaf spring member 50 includes a pressing portion 51 pressed into the fixed housing 11 and a protrusion portion 52 projecting from the side end surface of the fixed housing 11 integrally. The protrusion portion 52 is bent generally vertically from one end portion (lower end portion in the drawing) of the pressing portion 51, and is used, like the fitting hardware 13 for fixing (FIG. 5), to fix the fixed housing 11 to the substrate board 3.

The pressing portion 51 includes a base portion 53 to which the protrusion portion 52 is connected, a first leaf spring portion 54 rising up from the base portion 53, and a second leaf spring portion 55 formed inside the first spring portion 54 via a generally U-shaped through-hole 57. The base portion 53 is formed wider than the protrusion portion 52, and wider than the first spring portion 54. The end portion (upper end portion in FIG. 25) of the first spring portion 54 is formed in the shape of a circular arch, and is bent obliquely toward the protrusion portion 52 to form a bent portion 54a. The second leaf spring portion 55 rises up from the base portion 53, and the end portion (upper end portion in FIG. 25) of the second leaf spring portion 55 is bent obliquely toward the protrusion 52 to form a bent portion 55a. The bent portion 55a is formed wider than the proximal end portion of the second leaf spring portion 55, and both ends in width direction are curved toward the protrusion portion 52. A housing space 56 for housing the protrusion portion 29 of the housing 20 is formed between the bent portions 54a and 55a. The height of the housing space 56 is nearly equal to outer diameter of the protrusion portion 29, and the width of the housing space 56 is larger than outer diameter of the protrusion portion 29. Therefore, the protrusion portion 29 is slidable in the width direction in the housing space 56.

As shown in FIG. 23, a notch 11b is provided at the end of the fixed housing 11 of the plug 1. The bent portions 54a and 55a of the leaf spring member 50 are elastically deformable outside the housing 10 via the notch 11b without interfering with the housing 10. When the housing 10 is pressed into the housing 20 in order to fit the housing 20 of the receptacle 2 into the housing 10 of the plug 1, the first bent portions 54a of the leaf spring member 50 is pushed and opened outward by the protrusion portion 29, so that the protrusion portion 29 climbs over the bent portion 54a to be contained in the housing space 56. When the protrusion portion 29 is contained in the housing space 56, the bent portion 54a is restored by its own spring force, and the upper and lower ends of the protrusion portion 29 is held between the bent portions 54a and 55a so that the protrusion portion 29 is elastically supported by the leaf spring member 50.

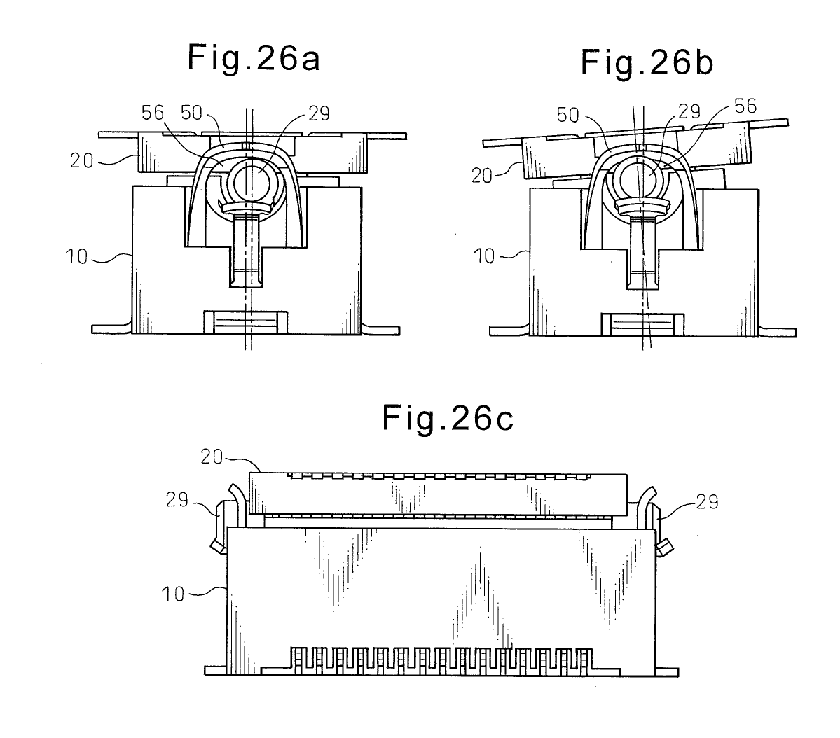

In this configuration, displacement of the protrusion portion 29 in the housing space 56 is tolerated to some extent, and the housings 10 and 20 can be fitted to each other with positional deviation between the housings 10 and 20 absorbed by this displacement. For example, when the housing 20 is floating in the width direction relative to the housing 10 as shown in FIG. 26a, or when the housing 20 is rotated relative to the housing 10 as shown in FIG. 26b, or when the housing 20 is displaced in longitudinal direction relative to the housing 10 as shown in FIG. 26c, the housings 10 and 20 can be fitted to each other. The displacement of the protrusion portion 29 at the time of fitting between the housings is restricted by the spring force of the leaf spring member 50. By engaging the housings 10 and 20 with each other in this way via the leaf spring member 50, the relative displacement of the housings 10 and 20 at the floating position can be restricted while absorbing the positional deviation between the housings 10 and 20. Therefore, sliding of the terminal portions 153 and 253 of the contacts 15 and 25 in vertical direction can be suppressed, and wear of the terminal portions 153 and 253 due to micro-sliding can be prevented.

Although, in the embodiment described above, the spring portion 252 is formed between the base portion 251 and the terminal portion 253 in the elongated shape, the configuration of the support part for supporting the terminal portion 253 in a manner movable relative to the housing 20, is not limited to that described above. Although the support part is provided in the contact 25 of the receptacle 2, the support part may be provided in the contact 15 of the plug 1, or the support part may be provided in both contacts 15 and 25 of the plug 1 and the receptacle 2, respectively. Although the positional deviation absorbing mechanism PA is provided in the plug 1, the positional deviation absorbing mechanism may be provided in the receptacle 2, or may be provided both in the plug 1 and in the receptacle 2.

Although, in the embodiment described above, each contact 15 and 25 of the plug 1 and the receptacle 2 is disposed in two rows in width direction, it is also possible to dispose the contact 15 and 25 other than in two rows. The configurations of the plug 1 and the receptacle 2 are not limited to that described above. The present invention is not limited to the floating connector described in the above embodiments, provided that the features and functions of the present invention can be realized.

In accordance with the present invention, a support part for supporting the terminal portion is provided in at least one of the plug contact and the receptacle contact so as to support in a manner movable relative to the supporting housing, so that sliding wear due to friction between the terminal portions can be suppressed.

1. A floating connector comprising:
a receptacle having a receptacle contact and a receptacle housing for supporting the receptacle contact;
a plug having a plug contact and a plug housing for supporting the plug contact; and
a positional deviation absorbing mechanism provided in at least one of the receptacle and the plug for capable of absorbing a positional deviation between the receptacle housing and the plug housing at a time of fitting between the receptacle housing and the plug housing;
wherein each of the receptacle contact and the plug contact has a terminal portion abutted to each other at the time of fitting between the receptacle housing and the plug housing; and
wherein at least one of the receptacle contact and the plug contact has a support part for supporting the terminal portion in a manner movable relative to the supporting housing.

2. The floating connector of claim 1, wherein the support part has a spring structure, the spring structure being elastically deformable.

3. The floating connector of claim 1, wherein the positional deviation absorbing mechanism is provided in one of the receptacle housing and the plug housing, and the support part is provided in the other of the receptacle housing and the plug housing.

4. The floating connector of claim 1, wherein each of the receptacle housing and the plug housing has a engaging part, for engaging with each other at the time of fitting between the receptacle housing and the plug housing.

5. The floating connector of claim 4, wherein the floating connector further comprises an urging member for urging the receptacle housing and the plug housing in a direction separating them from each other at the time of fitting between the receptacle housing and the plug housing.

6. The floating connector of claim 4, wherein the engaging part comprises:
a protrusion portion provided on one of the receptacle housing and the plug housing, and projected generally perpendicular to a direction fitting between the receptacle housing and the plug housing; and
a leaf spring member attached to the other of the receptacle housing and the plug housing, with which the protrusion portion engages at the time of fitting between the receptacle housing and the plug housing.
